(19) United States
(12) Patent Application Publication
(10) Pub. No.: US 2016/0365083 A1
(43) Pub. Date: Dec. 15, 2016

(54) Low-Power-Consumption Active Noise-Reduction In-Ear Music Headphones and Method for Noise Reduction

(71) Applicant: SHENZHEN AEROSPACE GOLDEN SHINE TECHNOLOGY CO.,LTD., Shenzhen, Guangdong (CN)

(72) Inventors: Qingshan Bao, Shenzhen, Guangdong (CN); Shangfeng Shi, Shenzhen, Guangdong (CN)

(21) Appl. No.: 15/109,135

(22) PCT Filed: Jun. 3, 2015
(86) PCT No.: PCT/CN2015/080704

§ 371 Date: Jun. 30, 2016

(30) Foreign Application Priority Data
Feb. 9, 2015 (CN) 201510068034.9

(51) Int. Cl. G10K 11/178; H04R 1/10

(52) U.S. Cl. CPC G10K 11/1786; H04R 1/1016; G10K 2210/3028; H04R 2460/01

(57) ABSTRACT

The present invention relates to a low-power-consumption active noise-reduction in-ear music headphone and a method for noise reduction. The headphone comprises an audio plug, in-ear earplugs and a noise-reduction control board, wherein the noise-reduction control board comprises a low-power-consumption active noise reduction circuit, which comprises a noise processing channel, an audio signal channel, and a sound mixing circuit connected with output ends of the two channels; and the sound mixing circuit is a by-pass switch consisting of two mutually independent low voltage drop diodes. The method comprises: processing ambient noise signal to generate a reverse noise signal, mixing the reverse noise signal with an audio signal, and outputting the mixed sound to a loudspeaker to generate a sound wave containing reverse noise in an auricular cavity, in which the reverse noise and the ambient noise transmitted into the auricular cavity from an environment counteract with each other to reduce noise.

### TECHNICAL FIELD

The present invention relates to noise-reduction headphones, and in more particular to a low-power-consumption active noise-reduction in-ear music headphone and a method for noise reduction thereof

### BACKGROUND ART

Power supply sources are usually very small in carry-on mobile electronic devices due to their size and weight. A battery of a pair of active noise-reduction music headphones does not exceed 20 mA, therefore, power consumption is a big problem. Such headphones in the prior art have the minimum power consumption of 12 mA on average, and have a continuous service time not exceeding 2 hours, therefore, it is very necessary to make improvements. In addition, the active noise-reduction music headphones in the prior art also have the problems of lower noise-reduction depth, narrower width, and ground noise present in noise reduction during headphone startup.

### SUMMARY OF THE INVENTION

An object of the present invention is to provide a low-power-consumption active noise-reduction in-ear music headphone, to solve the technical problems of large power consumption and short continuous service time of the active noise-reduction in-ear music headphones in the prior art.

A specific technical solution of the present invention is as follows:

A low-power-consumption active noise-reduction in-ear music headphone, comprising an audio plug, in-ear earplugs and a noise-reduction control board connected therebetween, wherein the noise-reduction control board comprises a low-power-consumption active noise reduction circuit, which comprises a noise processing channel for processing a sampled signal of ambient noise, an audio signal channel, and a sound mixing circuit connected with output ends of the two channels; the sound mixing circuit is a by-pass switch consisting of two mutually independent low voltage drop diodes; and positive electrodes of the two diodes are connected with the output ends of the two channels correspondingly, and negative electrodes of the same are connected with two wiring terminals of loudspeakers in the earplugs correspondingly.

In the low-power-consumption active noise-reduction in-ear music headphone as described above, to further reduce the influence to an audio signal and achieve a better noise-reduction effect, preferably, voltage drops of the two diodes are both less than 0.1V.

In the low-power-consumption active noise-reduction in-ear music headphone as described above, to reduce delay and further decrease power consumption, preferably, the noise processing channel comprises an analog filter and an adaptive digital filter, which are connected in sequence from an input end to an output end of the channel.

In the low-power-consumption active noise-reduction in-ear music headphone as described above, preferably, the analog filter is a low-pass filter having an amplification and phase inversing module.

In the low-power-consumption active noise-reduction in-ear music headphone as described above, preferably, the adaptive digital filter comprises a wavetrap module.

In the low-power-consumption active noise-reduction in-ear music headphone as described above, to achieve a better noise-reduction effect, preferably, the acoustic features of the loudspeakers are matched with the features of the noise processing channel.

In the low-power-consumption active noise-reduction in-ear music headphone as described above, preferably, the noise processing channel comprises two inputs, one being a sound pick-up configured on the noise-reduction control board or the earplugs, and the other being a sound pick-up on an audio source device connected through the audio plug, and the two inputs are connected with a selector switch.

The present invention also provides a method for noise reduction of a low-power-consumption in-ear music headphone, comprising: processing an ambient noise signal collected though a sound pick-up by a noise processing channel to generate a reverse noise signal corresponding to an ambient noise to be output to one input end of a by-pass switch, mixing the reverse noise signal with an audio signal from the other input end of the by-pass switch together by the by-pass switch, and outputting the mixed sound to the same loudspeaker to generate a sound wave containing reverse noise in an auricular cavity, in which the reverse noise and the ambient noise transmitted into the auricular cavity from an environment counteract with each other to realize noise reduction.

In the method for noise reduction of the low-power-consumption in-ear music headphone as described above, preferably, processing the ambient noise signal in the noise processing channel comprises: carrying out rapid amplification, low-pass filtering and phase reversing by an analog filter at first, and then processing by an adaptive digital filter.

In the method for noise reduction of the low-power-consumption in-ear music headphone as described above, preferably, the processing performed by the adaptive digital filter on the noise signal comprises: discretization processing, waveform correcting, filtering, and automatic adjusting of frequency, phase, frequency change rate and amplitude of the signal.

The pair of noise-reduction headphones provided by the present invention has the following advantageous effects that:

Due to sound mixing performed by the by-pass switch as described above, the noise-reduction power consumption is greatly reduced, and a power consumption value is only one tenth that of a traditional noise reduction manner (in which a power amplifier is employed for sound mixing); and moreover, with application of the noise processing channel combining the analog filter and the adaptive digital filter, not only is time delay reduced, but also the power consumption is further reduced.

### BRIEF DESCRIPTION OF THE DRAWINGS

FIG. 1 is a block diagram of a circuit for low-power-consumption active noise-reduction in-ear music headphones in some embodiments of the present invention;

FIG. 2 is a circuit diagram of a sound mixing circuit of the low-power-consumption active noise-reduction in-ear music headphones shown as FIG. 1; and

FIG. 3 is an acoustic feature diagram of loudspeakers of the low-power-consumption active noise-reduction in-ear music headphones of the present invention.

### DESCRIPTION OF THE PREFERRED EMBODIMENTS

The present invention will be further illustrated below with reference to the attached drawings and the embodiments. The description in more detail aims to help to understand the present invention, instead of limiting the present invention. According to the contents disclosed by the present invention, those skilled in the art shall understand that the present invention can be implemented even without some or all of these specific details. Under other circumstances, to avoid weakening the inventiveness of the present invention, the well-known circuits, methods, operation processes and the like will not be described in detail.

The pair of low-power-consumption active noise-reduction in-ear music headphones of the present invention comprises: an audio plug, in-ear earplugs and a noise control board, where the in-ear earplugs are connected with the audio plug through first headphone wires on one hand, and are connected with loudspeakers in the in-ear earplugs through second headphone wires on the other hand. The noise-reduction control board comprises a low-power-consumption active noise reduction circuit.

FIG. 1 shows a circuit structure for the low-power-consumption active noise-reduction in-ear music headphones in some embodiments. With reference to FIG. 1, the low-power-consumption active noise reduction circuit comprises: a noise processing channel 20 for processing a sampled signal of ambient noise, an audio signal channel 40, and a sound mixing circuit 50; an input end of the noise processing channel 20 is connected with a sound pick-up 10; an input end of the audio signal channel 40 is connected with an audio plug 30; and output ends of the noise processing channel 20 and the audio signal channel 40 are connected with the sound mixing circuit 50. It is preferred to employ a silicon microphone as the sound pick-up to improve the signal to noise ratio and sensitivity for collection.

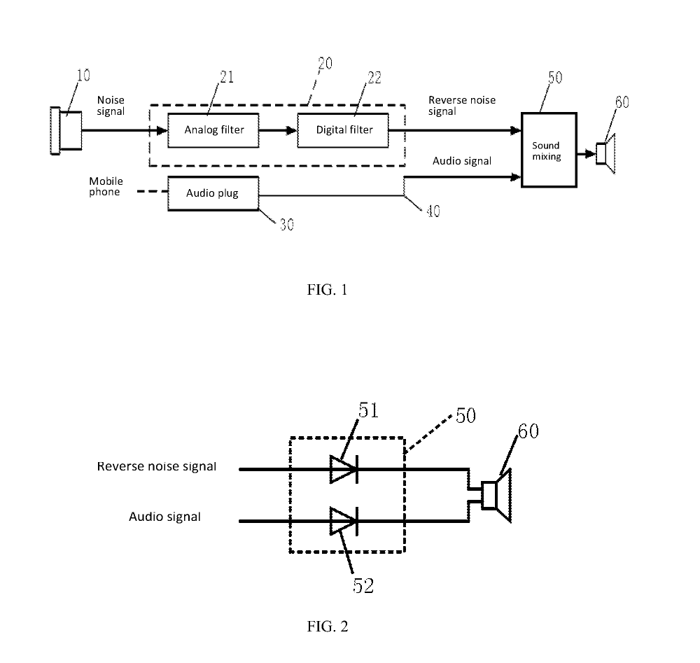

FIG. 2 shows a structure of the sound mixing circuit 50. As shown in FIG. 2, the sound mixing circuit 50 is a by-pass switch consisting of two mutually independent low voltage drop diodes 51 and 52. In combination with FIG. 1 and FIG. 2, positive electrodes of the two diodes 51 and 52 are connected with the output ends of the noise processing channel 20 and the audio signal channel 40 correspondingly, and negative electrodes of the same are connected with two wiring terminals of loudspeakers 60 in the earplugs correspondingly.

After the noise reduction circuit as described above is activated, the ambient noise signal collected though the sound pick-up 10 is processed by the noise processing channel 20 to generate a reverse noise signal corresponding to ambient noise to be output to an input end of the by-pass switch (i.e., the sound mixing circuit 50) and mixed with an audio signal from the other input end of the by-pass switch (i.e., the sound mixing circuit 50) together by the by-pass switch to be output to the same loudspeaker 60, thereby generating a sound wave containing reverse noise in an auricular cavity, in which the reverse noise and the ambient noise transmitted into the auricular cavity from an environment counteract with each other to realize noise reduction.

The noise-reduction headphones in the prior art generally employ a power amplifier for sound mixing, which is higher in power consumption. With the by-pass switch having the structure as described above employed for sound mixing, the power consumption is reduced greatly, and a power consumption value is only one tenth that of a traditional noise reduction manner. It is worth to note that the diodes forming the by-pass switch as described above must be low voltage drop diodes, otherwise, the quality of the audio signal and the noise reduction effect will be affected. It is preferred that the voltage drops of the diodes are less than 0.1 V. Moreover, if the reverse noise signal and the audio signal are directly mixed at the loudspeakers 60 without configuring the by-pass switch as described above, impedances of the loudspeakers 60 per se will make the mixing ineffective, i.e., noise reduction cannot be realized.

To reduce time delay and further decrease power consumption, the noise processing channel 20 comprises an analog filter 21 and an adaptive digital filter 22, which are in connection from an input end to an output end of the channel in sequence. That is, the noise signal is processed in a manner of combining the analog filter and the digital filter. The analog filter is featured with high speed but coarse effect, and the digital filter is featured with accurate control but low speed and time delay. Here, the analog filter 21 is firstly employed for rapid coarse processing, an effective waveform obtained after the processing is subjected to digital discretization and enters the adaptive digital filter 22 for accurate shaping, and with a wavetrap technology, a reverse waveform of the noise is simulated accurately, thereby maximally counteracting the noise.

It is preferred to employ a low-pass filter having an amplification and phase reversing module as the analog filter 21. To rapidly carry out amplification, low-pass filtering and phase reversing on micro signals collected by the sound pick-up. The selection of an amplification factor, a phase and a cut-off frequency of the analog filter 21 determines the reducibility to the noise, thereby further affecting the noise reduction effect and the ground noise effect. It is preferred to set the analog filter 21 to be 3 to 5 in the amplification factor, 180 degrees of turnover in the phase change, and 4 KHz in the cut-off frequency.

The adaptive digital filter 22 preferably comprises a wavetrap module. Further, it is also possible to more rapidly and accurately simulate the reverse waveform of an input signal by setting a center frequency, width, and depth of a wavetrap algorithm. It is preferred to set the wavetrap algorithm to be 3.3 KHz in the center frequency, 300 Hz in the width and above 15 dB in the depth. The digital filter 22 receives a signal output by the analog filter 21 for further processing, comprising discretizing the signal, accurately correcting the noise waveform, and automatically adjusting adaptive rates including frequency, phase, frequency change rate, amplitude and the like of the input signal. By processing the noise signal based on the analog filter and in combination with the digital filter, the problems of low speed and high operation load during direct application of the digital filter are solved, and the power consumption of a chip can be converged and reduced rapidly.

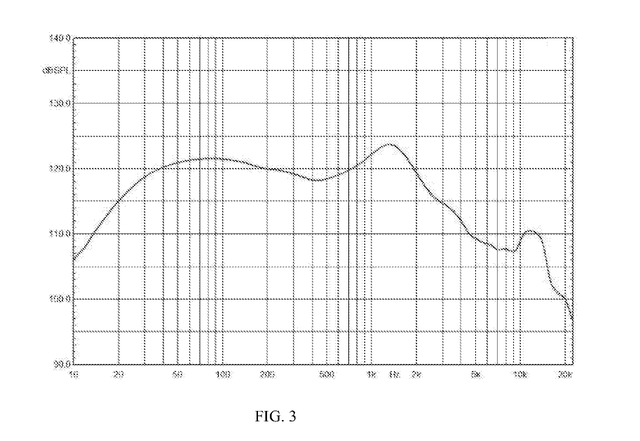

To achieve a better noise-reduction effect, a loudspeaker having acoustic features matched with the features of the noise processing channel 20 is employed as the loudspeaker 60, and FIG. 3 shows the acoustic features of the loudspeaker 60 employed in some embodiments.

In some embodiments, the noise processing channel 20 comprises two inputs, one being a sound pick-up configured on the noise-reduction control board or the earplugs and the other being a sound pick-up on an audio source device connected through the audio plug 30, and the two inputs are connected with a selector switch. With this design, a common sound pick-up can be employed for the noise-reduction control board or the earplugs to reduce the cost of the headphones, and when a mobile phone and the like is employed as an audio source device, a silicone microphone on the mobile phone can be utilized to collect environment noise to achieve a better noise reduction effect.

In some embodiments, the noise processing channel 20 can be selected to be opened or closed. When the noise processing channel 20 is closed, the music headphones can be used as common headphones.

The pair of active noise-reduction in-ear music headphones of the present invention has the features of super low-power-consumption. In addition, by adopting an accurate depth filtering technology combining a feed forward control technology, the analog filter and the adaptive digital filter, and the sound mixing technology as described above in at least some embodiments, the depth and width for noise-reduction are improved effectively, the ground noise is eliminated, and high-quality active noise reduction is realized while the quality of the audio signal is not changed. By experiments, the active noise-reduction in-ear music headphones in some embodiments can provide the noise-reduction depth of 35 db, the noise-reduction width of 2 kHz, have the continuous service time up to 20 hours under the condition that the battery capacity of the headphones is only 20 mA, and have the power consumption being one tenth that of like headphones.

1. A low-power-consumption active noise-reduction in-ear music headphone, comprising an audio plug, in-ear earplugs and a noise-reduction control board connected therebetween, wherein said noise-reduction control board comprises a low-power-consumption active noise reduction circuit, which comprises a noise processing channel (20) for processing a sampled signal of ambient noise, an audio signal channel (40), and a sound mixing circuit (50) connected with output ends of said two channels; said sound mixing circuit is a by-pass switch consisting of two mutually independent low voltage drop diodes (51 and 52); and positive electrodes of said two diodes (51 and 52) are connected with the output ends of said two channels correspondingly, and negative electrodes of the same are connected with two wiring terminals of loudspeakers (60) in said earplugs correspondingly.

2. The low-power-consumption active noise-reduction in-ear music headphone according to claim 1, wherein voltage drops of said two diodes are both less than 0.1V.

3. The low-power-consumption active noise-reduction in-ear music headphone according to claim 1, wherein said noise processing channel (20) comprises an analog filter (21) and an adaptive digital filter (22), which are in connection from an input end to an output end of said channel in sequence.

4. The low-power-consumption active noise-reduction in-ear music headphone according to claim 3, wherein said analog filter is a low-pass filter having an amplification and phase inversing module.

5. The of low-power-consumption active noise-reduction in-ear music headphone according to claim 3, wherein said adaptive digital filter comprises a wavetrap module.

6. The low-power-consumption active noise-reduction in-ear music headphone according to any one of claims 3, wherein the acoustic features of said loudspeakers are matched with acoustic features of said noise processing channel.

7. The low-power-consumption active noise-reduction in-ear music headphone according to claim 1, wherein said noise processing channel comprises two inputs, one being a sound pick-up configured on said noise-reduction control board or said earplug and the other being a sound pick-up on an audio source device connected through said audio plug, and said two inputs are connected with a selector switch.

8. A method for noise reduction of a low-power-consumption in-ear music headphone, comprising: processing an ambient noise signal collected through a sound pick-up by a noise processing channel to generate a reverse noise signal corresponding to ambient noise to be output to one input end of a by-pass switch, mixing said reverse noise signal with an audio signal from the other input end of said by-pass switch together by said by-pass switch, and outputting the mixed sound to the same loudspeaker to generate a sound wave containing reverse noise in an auricular cavity, in which said reverse noise and said ambient noise transmitted into the auricular cavity from an environment counteract with each other to realize noise reduction.

9. The method for noise reduction of the low-power-consumption in-ear music headphone according to claim 8, wherein processing said ambient noise signal in said noise processing channel comprises: carrying out rapid amplification, low-pass filtering and phase reversing by an analog filter at first, and then processing by an adaptive digital filter.

10. The method for noise reduction of the low-power-consumption in-ear music headphone according to claim 9, wherein the processing performed by said adaptive digital filter on said noise signal comprises: discretization processing, waveform correcting, filtering, and automatic adjusting of frequency, phase, frequency change rate and amplitude of said signal.

11. The low-power-consumption active noise-reduction in-ear music headphone according to claim 4, wherein the acoustic features of said loudspeakers are matched with acoustic features of said noise processing channel.

12. The low-power-consumption active noise-reduction in-ear music headphone according to claim 5, wherein the acoustic features of said loudspeakers are matched with acoustic features of said noise processing channel.
